(19) United States
(12) Patent Application Publication
(10) Pub. No.: US 2013/0299375 A1
(43) Pub. Date: Nov. 14, 2013

(54) Forming Mold for Plastic Products, Using Method Thereof, and Packaging Box for Liquid Crystal Glass

(71) Applicants: Shihhsiang Chen, Shenzhen (CN); Yicheng Kuo, Shenzhen (CN); Jiahe Cheng, Shenzhen (CN)

(72) Inventors: Shihhsiang Chen, Shenzhen (CN); Yicheng Kuo, Shenzhen (CN); Jiahe Cheng, Shenzhen (CN)

(21) Appl. No.: 13/515,613

(22) PCT Filed: May 16, 2012
(86) PCT No.: PCT/CN2012/075606

§ 371 Date: Jun. 13, 2012

(30) Foreign Application Priority Data
May 10, 2012 (CN) 201210143241.2

(51) Int. Cl. B65D 85/48; B29C 33/48; B29C 39/26

(52) U.S. Cl. 206/454; 249/64; 264/219

(57) ABSTRACT

The invention relates to the field of packages and molds, and more particularly to a forming mold for plastic products and a using method thereof, and further relates to a packaging box for liquid crystal glass. The mold is used for molding box bodies of at least two different of the packaging box for liquid crystal glass; A cavity(es) of the mold is of a joining structure, and comprises a group of shared splicing piece(s), and at least two groups of selected splicing pieces. The cavities formed by the shared splicing piece(s) and different groups of selected splicing pieces are in different sizes, and are respectively used for forming box bodies of different sizes. The mold can mold box bodies of at least two different sizes of the packaging box for liquid crystal glass. Because the shared splicing piece(s) can be shared, the development cost of the mold is lower than the cost of separately developing two sets of integrated box body molds. In addition, the development cycle can be shortened.

### TECHNICAL FIELD

The invention relates to the field of packages and molds, and more particularly to a forming mold for plastic products and a using method thereof, and further relates to a packaging box for liquid crystal (LC) glass.

### BACKGROUND

Conventional liquid crystal display (LCD) devices employ various glass plates and glass components. As a brittle material, glass is easily broken and then scrapped when being knocked or shaken by external force. Even the friction between glass plates possibly causes the glass plates to be scratched or the circuits on the glass plates to be damaged. Therefore, how to safely and effectively transport liquid crystal glass becomes a crucial issue.

In the prior art, the frequently-used packaging mode is that: a plurality of liquid crystal glass are stacked and then put in a packaging box which generally includes an upper cover and a box body, and buffer sheets are arranged among the liquid crystal glass. The packaging box is generally made of expanded polypropylene (EPP), expanded polyethylene (EPE), expanded polystyrene (EPS), etc. The expanded materials have the advantages of better buffer performance, certain hardness, no drop of powdered scraps, and no need of worrying about affecting the environment of the dust-free room. However, the expanded materials are expensive, which don't favor the reduction of packaging cost.

### SUMMARY

In view of the above-described problems, the aim of the invention is to provide a low-cost packaging box for liquid crystal glass made of different materials, a forming mold for plastic products of a molding box, and a using method thereof.

A first technical scheme of the invention is that: a packaging box for liquid crystal glass comprises a box body; the box body is internally provided with buffer blocks which are made of material different from that of the box body and have buffer performance superior to that of the box body. The packaging box for liquid crystal glass comprises two or more sets of buffer blocks of different sizes; multiple sets of buffer blocks enable the packaging box to contain various liquid crystal glass of different sizes.

Preferably, the packaging box for liquid crystal glass comprises two or more box bodies of different sizes; the containing sizes of the packaging boxes for liquid crystal glass formed by the same set of buffer blocks and different box bodies are different. Thus, the combination forms of buffer blocks and box bodies are various, and more packaging boxes for liquid crystal glass of different sizes can be formed. For example, two sets of buffer blocks and two box bodies can form four packaging boxes for liquid crystal glass of different sizes, thereby being more flexible.

Advantages of the technical scheme of the invention are summarized below: the packaging box for liquid crystal glass of the invention is of a separated structure; the box bodies and the buffer blocks are respectively made of different materials, the buffer blocks are made of material with high buffer performance, and the box body is mainly used for fixing the buffer blocks and guaranteeing the strength of the whole packaging box. Thus, the box body can be made of ordinary plastic material and molded by a forming mold for plastic products without being made of expanded buffer material which has buffer effect and high cost, thereby reducing the cost of the packaging box. Each box body corresponds to two or more sets of buffer blocks of different sizes, namely the containing sizes of the packaging boxes formed by the same box body with different buffer blocks are different. Thus, the number of box body types are reduced, and the sharing performance of fittings is increased, thereby reducing the material cost and management cost.

A second technical scheme of the invention is that: a forming mold for plastic products, the mold is used for molding box bodies of at least two different sizes of the packaging box for liquid crystal glass. A cavity of the mold is of a splicing structure, and comprises one group of shared splicing piece(s), and at least two groups selected splicing pieces; the cavities formed by the shared splicing piece(s) and different groups of selected splicing pieces are in different sizes, and are respectively used for forming box bodies of different sizes. The mold further comprises a plurality of cores of different sizes; the cores are respectively matched with the cavities of different sizes.

Preferably, the shared splicing piece(s) is used for forming the bottom wall of the box body, and the selected splicing pieces are used for forming the four side walls of the box body; or the shared splicing piece(s) is used for forming partial bottom wall of the box body, and the selected splicing pieces are used for forming the four side walls and partial bottom wall of the box body.

Preferably, the number of the shared splicing piece(s) is one; each group of selected splicing pieces comprises four selected splicing pieces; the four selected splicing pieces are distributed around the shared splicing piece.

Preferably, the shared splicing piece(s) is used for forming the middle part of each side wall of the four side walls, and the selected splicing pieces are used for forming the bottom wall and the four frame corners of the box body.

Preferably, the number of the shared splicing piece(s) is four, and each group of selected splicing pieces comprises four frame corner splicing pieces and one bottom wall splicing piece; the four shared splicing pieces and the four frame corner splicing pieces make a rectangle, and the bottom wall splicing member is positioned in the middle of the rectangle.

Preferably, the shared splicing pieces are used for forming the four frame corners of the box body, and the selected splicing pieces are used for forming the bottom wall and the four side walls of the box body.

Preferably, the shared splicing pieces are used for forming the four frame corners of the box body and partial bottom wall of the box body, and the selected splicing pieces are used for forming the four side walls and partial bottom wall of the box body.

Preferably, the shared splicing pieces are used for forming the four frame corners and a part of each side wall of the four side walls of the box body, and the selected splicing pieces are used for forming the bottom wall and the rest part of each side wall of the four side walls of the box body.

Preferably, the core(s) is of a splicing structure as the same as that of the cavity, to reduce the cost to the maximum extent.

The invention further provides a using method of the aforementioned forming mold for plastic products, comprising the following steps:

Determining the size of the box body of the packaging box for liquid crystal glass to be produced;

Selecting one group of selected splicing pieces from multiple groups of selected splicing pieces corresponding to the size of the box body;

Splicing the shared splicing pieces with the selected splicing pieces which are selected, to form cavities; and

Selecting matching cores to form a complete mold.

In the invention, because the packaging box for liquid crystal glass is separately designed, namely the box bodies and the buffer blocks are disassembled and separately manufactured, the structure of the box bodies is simplified. The structures of all the corresponding parts of the box bodies are the same, such as positioning structure, reinforcing rib structure, etc., and are only different from each other in that: the overall length and width of the box bodies are different. Thus, forming molds for box bodies of different sizes have some same unit structures, and the same unit structures can save mold material cost, and processing cost by being shared.

The cavity of the forming mold for plastic products of the invention is of a splicing structure, and comprises one group of shared splicing piece(s), and at least two groups of selected splicing pieces; the cavities formed by the shared splicing pieces and different groups of selected splicing pieces are in different sizes, and are respectively used for forming box bodies of different sizes. The mold comprises a plurality of cores of different sizes; the cores are respectively matched with the cavities of different sizes. The mold of the invention can mold box bodies of at least two different sizes of the packaging box for liquid crystal glass. Because the shared splicing piece(s) can be shared, the development cost of the forming mold is lower than the cost of separately developing two sets of integrated box body molds. In addition, the development cycle can be shortened.

### BRIEF DESCRIPTION OF FIGURES

FIG. 1 is a structure diagram of an example of a packaging box for liquid crystal glass of the invention;

FIG. 2 is a disassembly diagram of a packaging box for liquid crystal glass of the invention;

FIG. 3 is an assembly diagram of a box body, a buffer spring and a tray of the invention.

FIG. 4 is a structure diagram of a packaging box for liquid crystal glass employing another set of buffer blocks of the invention;

FIG. 5 is a splicing diagram of a shared splicing piece matched with one group of selected splicing pieces of a forming mold for plastic products of a first example of the invention;

FIG. 6 is a splicing diagram of a shared splicing piece matched with another group of selected splicing pieces of a forming mold for plastic products of a first example of the invention;

FIG. 7 is a splicing diagram of a shared splicing piece matched with one group of selected splicing pieces of a forming mold for plastic products of a second example of the invention;

FIG. 8 is a splicing diagram of a shared splicing piece matched with another group of selected splicing pieces of a forming mold for plastic products of a second example of the invention;

FIG. 9 is a splicing diagram of a shared splicing piece matched with one group of selected-splicing pieces of a forming mold for plastic products of a third example of the invention;

FIG. 10 is a splicing diagram of a shared splicing piece matched with another group of selected splicing pieces of a forming mold for plastic products of a third example of the invention;

FIG. 11 is a splicing diagram of a shared splicing piece matched with one group of selected splicing pieces of a forming mold for plastic products of a fourth example of the invention;

FIG. 12 is a splicing diagram of a shared splicing piece matched with another group of selected splicing pieces of a forming mold for plastic products of a fourth example of the invention;

FIG. 13 is a splicing diagram of a shared splicing piece matched with one group of selected splicing pieces of a forming mold for plastic products of a fifth example of the invention; and

FIG. 14 is a splicing diagram of a shared splicing piece matched with another group of selected splicing pieces of a forming mold for plastic products of a fifth example of the invention;

Legends: 1. box body; 11. L-shaped clamping arm; 12. slot; 2. buffer block; 21. clamping part; 3. tray; 31. containing groove; 4. buffer spring; 51. side wall splicing piece; 52. bottom wall splicing piece; 53. frame corner splicing piece.

### DETAILED DESCRIPTION

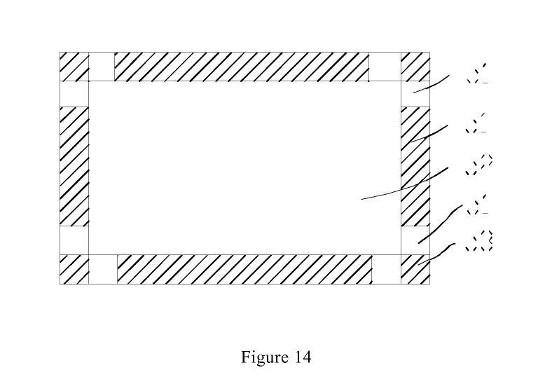

The invention provides a packaging box for liquid crystal glass. As shown in FIGS. 14, the packaging box for liquid crystal glass comprises box bodies 1; the box body 1 is internally provided with buffer blocks 2 which are made of material different from that of the box body and have buffer performance superior to that of the box body 1. Each box body 1 corresponds to two or more sets of buffer blocks 2 of different sizes; multiple sets of buffer blocks 2 enable the packaging box to contain various liquid crystal glass of different sizes.

The packaging box for liquid crystal glass of the invention is of a separated structure. The box bodies 1 and the buffer blocks 2 are respectively made of different materials. The buffer performance of the buffer blocks 2 is superior to that of the box bodies 1. The buffer blocks 2 are made of material with good buffer performance, such as EPP, EPE, EPS, etc., and the box bodies 1 are mainly used for fixing the buffer blocks 2 and ensuring the strength of the whole packaging box. Thus, the box bodies 1 are made of ordinary plastic material such as ABS, HDPE, etc. and are injection molded by a forming mold for plastic products. Because the box bodies 1 are not made of expanded buffer material which has buffer effect and high cost, the cost of the packaging box is reduced. Each box body 1 corresponds to two or more sets of buffer blocks 2 of different sizes, namely the containing sizes of the packaging boxes formed by the same box body 1 with different buffer blocks 2 are different. Thus, the number of the box body 1 types are reduced, and the sharing performance of fittings is increased, thereby reducing the material cost and management cost.

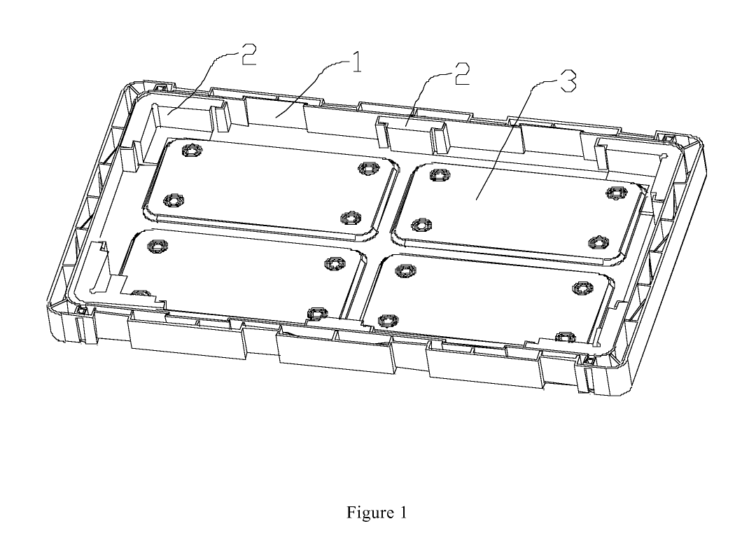

In the example, as shown in FIG. 1, the buffer blocks 2 are thin; thus, the containing size of the packaging box is large, to contain large-size liquid crystal glass. The buffer blocks 2 are arranged on the four corners inside the box body 1, and the middle parts inside the side walls of the box body 1 are also provided with buffer blocks 2. Thus, the liquid crystal glass is better positioned on the corners and sides to prevent shake. Both the side surfaces and the bottom surfaces of the buffer blocks 2 play a buffer role, and both positioning by corners and positioning by sides are feasible positioning methods.

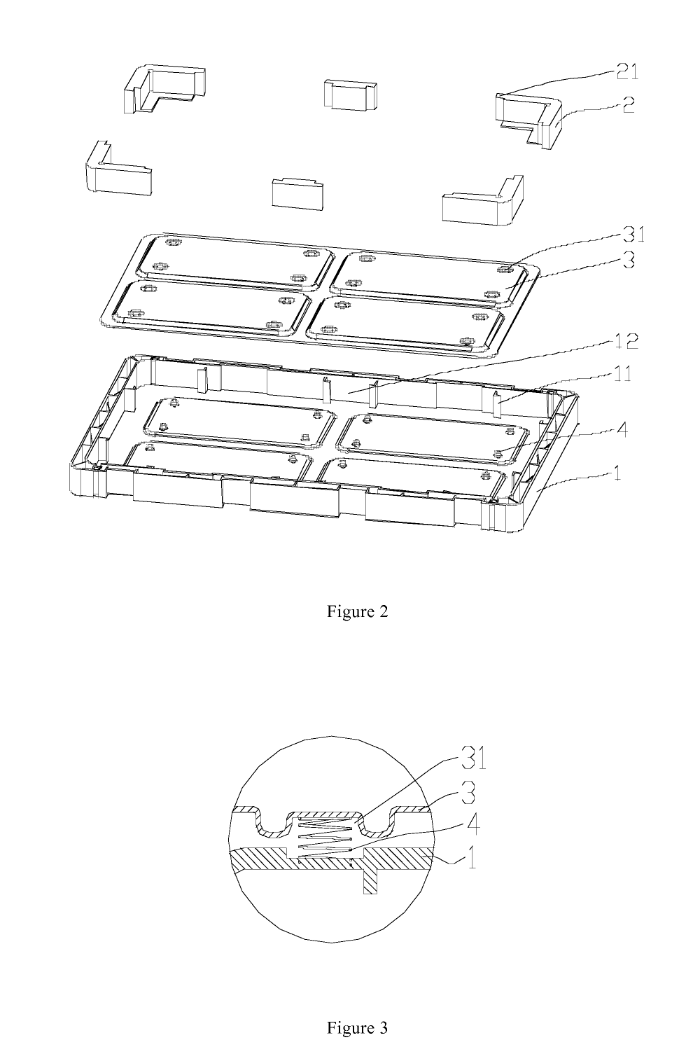

In the example, as shown in FIG. 2, the inner wall of the box body 1 is provided with L-shaped clamping arms 11, each pair of L-shaped clamping arms 11 form a slot 12, the buffer block(s) 2 is provided with a clamping part 21, the clamping part 21 is inserted in the slot 12, and the buffer block 2 is fixed on the box body 1. The buffer block 2 here is in a step shape, the wider part of the buffer block 2 is inserted in the slot 12, and the narrower part of the buffer block 2 is protruded from the slot 12. Because the box body 1 is injection molded, the L-shaped clamping arms 11 are easily arranged on the inner wall of the box body 1 to firmly fix the buffer blocks 2 on the box body 1, and are conveniently and quickly assembled.

In the example, the bottom of the box body 1 is provided with trays 3, and buffer springs 4 are arranged between the box body 1 and the trays 3. The buffer springs 4 are distributed in multiple positions of the bottom of the box body 1, and the buffer springs 4 support the trays 3 to enable the trays 3 to form larger buffer space in the upward and downward directions and obtain better buffer effect. The aim of arranging the buffer springs 4 on the four corners and the middle part of the box body 1 is to provide an uniform buffer force to the trays 3. The buffer springs 4 arranged on the middle part have a support function to the middle part of the trays 3, thereby reducing the requirement to the overall strength of the trays 3.

In the example, as shown in FIG. 3, the buffer springs 4 are arranged on the box body 1 and integratedly injection molded together with the box body 1, and the buffer springs 4 are reliably fixed and are not easy to fall off and lose, thereby avoiding affecting the balance of the trays 3. To ensure the accurate alignment of the trays 3 and the buffer springs 4, containing grooves 31 for containing the ends of the buffer springs 4 are specially arranged in the trays 3, and the surfaces of the trays around the containing grooves 31 are downwards depressed to enable the top outer surfaces of the containing grooves 31 to be flush with the planes of the trays. Thus, the planeness of the trays 3 is not affected. In addition, the containing grooves 31 are further used for guiding the buffer springs 4, to prevent the buffer springs 4 from deviating from the axis when being compressed; thus, the top outer surfaces of the containing grooves 31 are flush with the planes of the trays; therefore, the planeness of the planes of the trays 3 is not affected.

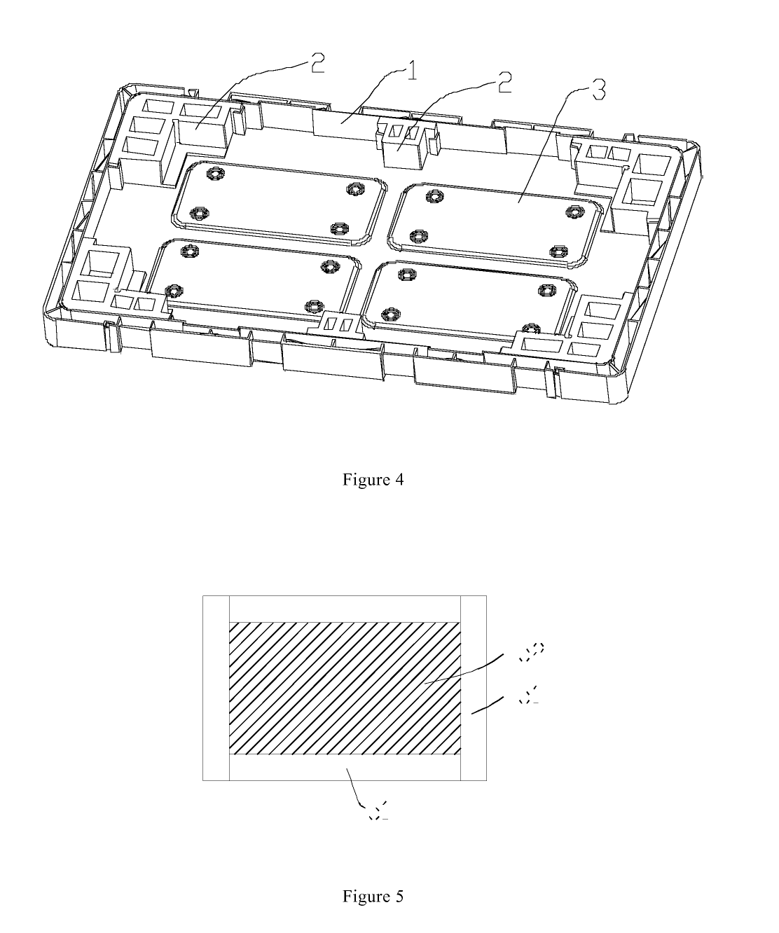

FIG. 4 shows a structure of the packaging box for liquid crystal glass employing another set of buffer blocks 2 of the invention. In the example, the buffer blocks 2 are thick, so that the containing size of the packaging box becomes small to contain small-size liquid crystal glass.

In the aforementioned example, the packaging box for liquid crystal glass further comprises two or more box bodies of different sizes; the containing sizes of the packaging boxes for liquid crystal glass formed by the same set of buffer blocks and different box bodies are different; thus, the composition forms of buffer blocks and box bodies are various, and more packaging boxes for liquid crystal glass of different sizes can be formed. For example, two sets of buffer blocks and two box bodies can form four packaging boxes for liquid crystal glass of different sizes, thereby being more flexible.

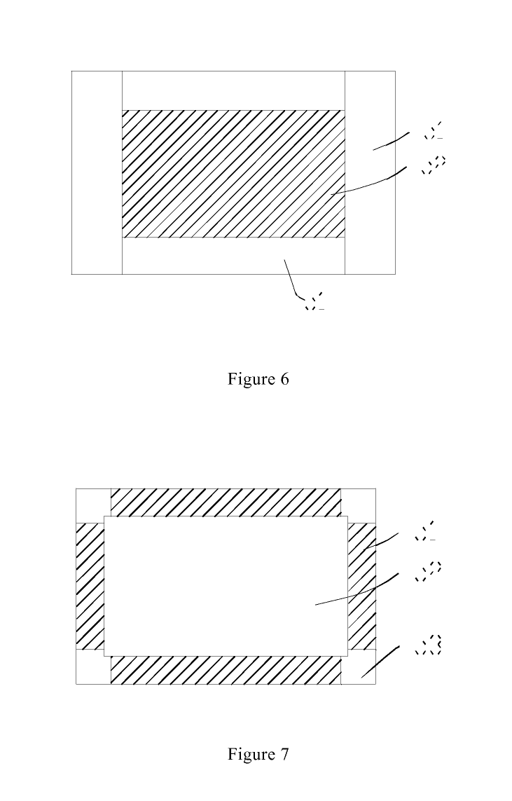

The invention further provides a forming mold for plastic products. FIG. 5 and FIG. 6 show a first example of the forming mold for plastic products of the invention. The mold is used for molding box bodies of at least two different sizes of the packaging box for liquid crystal glass. A cavity of the mold is of a splicing structure, and comprises one set of shared splicing piece(s), and at least two sets selected splicing pieces; the cavities formed by the shared splicing piece(s) and different sets of selected splicing pieces are in different sizes, and are respectively used for forming box bodies of different sizes. The mold further comprises a plurality of cores of different sizes; the cores are respectively matched with the cavities of different sizes. In the Figures, the splicing piece with section lines is a shared splicing piece, and the splicing piece without section lines is a selected splicing piece.

The using method of the forming mold for plastic products of the invention comprises the following steps:

Determining the size of the box body of the packaging box for liquid crystal glass to be produced;

Selecting one group of selected splicing pieces from multiple groups of selected splicing pieces corresponding to the size of the box body;

Splicing the shared splicing pieces with the selected splicing pieces which are selected, to form cavities; and

Selecting matching cores to form a complete mold.

In the invention, because the packaging box for liquid crystal glass is separately designed, namely the box bodies and the buffer blocks are disassembled and separately manufactured, the structure of box bodies is simplified. The structures of all the corresponding parts of the box bodies are the same, such as positioning structure, reinforcing rib structure, etc., and are only different from each other in that: the overall length and width of the box bodies are different. Thus, forming molds for molding box bodies of different sizes have some same unit structures, and the same unit structures can save mold material cost and processing cost by being shared.

The cavity of the forming mold for plastic products of the invention is of a splicing structure, and comprises one group of shared splicing piece(s), and at least two groups of selected splicing pieces; the cavities formed by the shared splicing piece(s) and different groups of selected splicing pieces are in different sizes, and are respectively used for forming box bodies of different sizes. The mold further comprises a plurality of cores of different sizes; the cores are respectively matched with the cavities of different sizes. The mold of the invention can mold box bodies of at least two different sizes of the packaging box for liquid crystal glass. Because the shared joining member(s) can be shared, the development cost of the mold is lower than the cost of separately developing two sets of integrated box body molds. In addition, the development cycle can be shortened.

In the example, the shared splicing piece(s) is used for forming the bottom wall of the box body, and the selected splicing pieces are used for forming the four side walls of the box body. Specifically, the shared splicing piece is the bottom wall splicing piece 52, and the number thereof is one. Each group of selected splicing pieces comprise four selected splicing pieces. The selected splicing pieces here are the side wall splicing pieces 51, and the four side wall splicing pieces 51 are distributed around the bottom wall splicing piece 52. As shown in FIG. 5, a group of small-size selected splicing pieces are used for forming a small-size box body. As shown in FIG. 6, a group of large-size selected splicing pieces are used for forming a large-size box body.

Optionally, in the example, the shared splicing piece can be only used for forming partial bottom wall of the box body, and the selected splicing pieces are used for forming the four side walls and rest partial bottom wall of the box body, and the similar advantages can also be obtained. The larger the forming area of the shared splicing piece is, the less the mold material is; thus, the mold cost is reduced.

Optionally, in the example, the core(s) can also be of a splicing structure, and comprises shared splicing piece(s), and selected splicing pieces. Thus, the mold cost can be further saved. Preferably, the specific splicing structure is the same as the splicing structure of the cavity, to reduce the cost to the maximum extent. Because the design principles are the same, the example will not give unnecessary details.

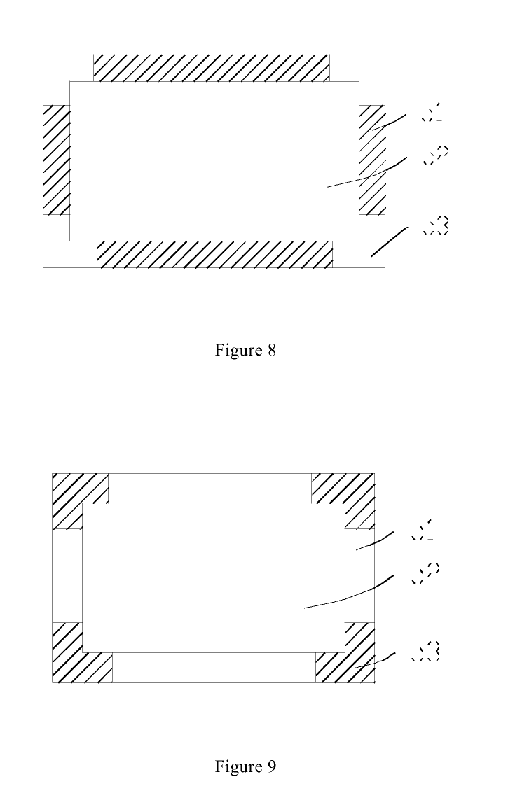

FIG. 7 and FIG. 8 show a second example of the forming mold for plastic products of the invention, and the second example is different from the first example in that: the shared splicing pieces are used for forming the middle part of each side wall of the four side walls of the box body, and the selected splicing pieces are used for forming the bottom wall and the four frame corners of the box body. Specifically, the shared splicing pieces are side wall splicing pieces 51, and the number thereof is four. Each group of selected splicing pieces comprise four frame corner splicing piece 53, and one bottom wall splicing piece 52; the four side wall splicing pieces 51 and the four frame corner splicing pieces 53 make a rectangle, and the bottom wall splicing piece 52 is positioned in the middle of the rectangle. As shown in FIG. 7, a group of small-size selected splicing pieces are used for forming a small-size box body. As shown in FIG. 8, a group of large-size selected splicing pieces are used for forming a large-size box body.

In the example, the four side wall splicing pieces 51 are shared splicing pieces, and can form box bodies of at least two different sizes of the packaging box for liquid crystal glass. Thus, development cost of the mold can be reduced, and the development cycle can be shortened.

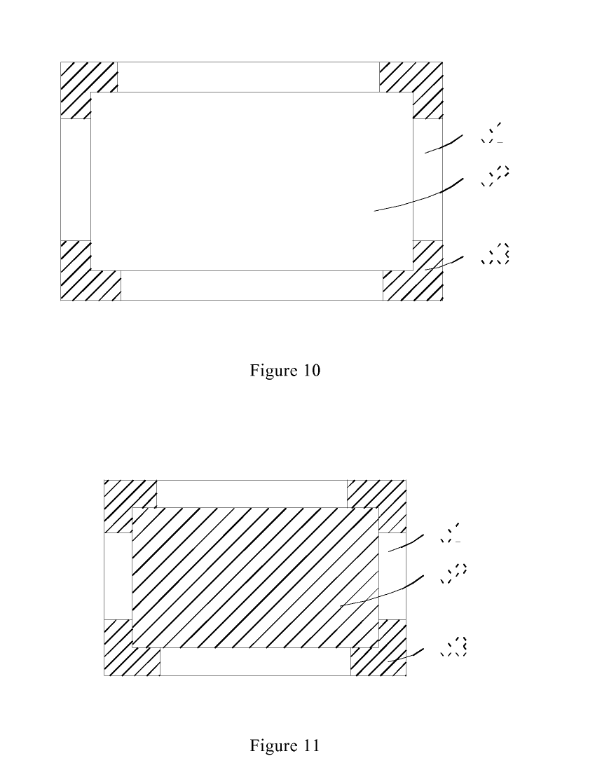

FIG. 9 and FIG. 10 show a third example of the forming mold for plastic products of the invention, and the third example is different from the second example in that: the shared splicing pieces are used for forming the four frame corners of the box body, and the selected splicing pieces are used for forming the bottom wall and the four side walls of the box body. Specifically, the shared splicing pieces are frame corner splicing pieces 53, and the number thereof is four. Each group of selected splicing pieces comprises four side wall splicing pieces 51, and one bottom wall splicing piece 52; the four side wall splicing pieces 51 and the four frame corner splicing pieces 53 form a rectangle, and the bottom wall splicing piece 52 is positioned in the middle of the rectangle. As shown in FIG. 9, a group of small-size selected splicing pieces are used for forming a small-size box body. As shown in FIG. 10, a group of large-size selected splicing pieces are used for forming a large-size box body.

In the example, the four frame corner splicing piece 53 are shared splicing pieces, and can form box bodies of at least two different sizes of the packaging box for liquid crystal glass. Thus, development cost of the mold can be reduced, and the development cycle can be shortened.

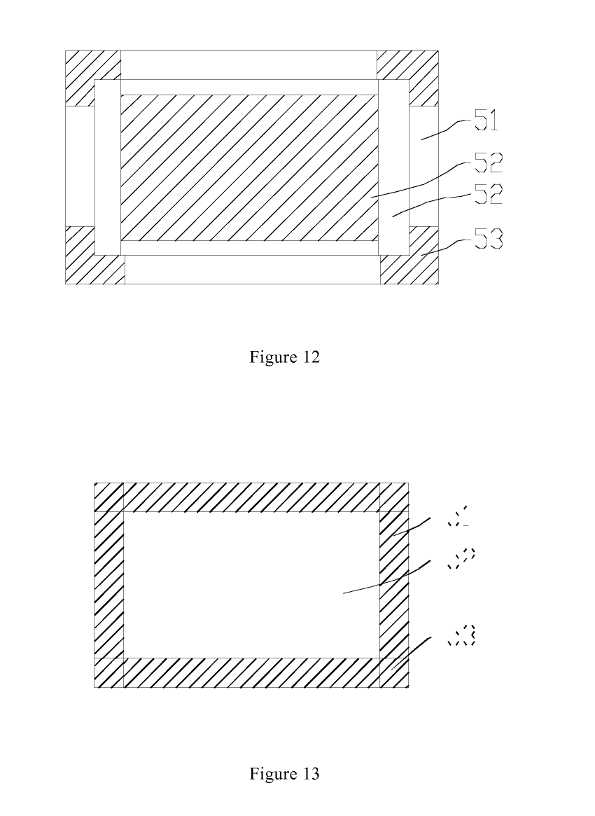

FIG. 11 and FIG. 12 show a fourth example of the forming mold for plastic products of the invention. The shared splicing pieces are used for forming the four frame corners of the box body and partial bottom wall of the box body, and the selected splicing pieces are used for forming the four side walls and partial bottom wall of the box body. Specifically, the shared splicing pieces comprise four frame corner splicing pieces 53, and one bottom wall splicing piece 52. Each group of selected splicing pieces comprises four side wall splicing pieces 51, and four bottom wall splicing pieces 52. The fourth example is different from the third example in that: the bottom wall splicing piece 52 used for forming the bottom wall of the box body is also designed into a shared splicing piece. When a large-size box body is formed, other bottom wall splicing pieces 52 are used to supplementarily form a complete cavity. As shown in FIG. 11, a group of small-size selected splicing pieces are used for forming a small-size box body. As shown in FIG. 12, a group of large-size selected splicing pieces are used for forming a large-size box body.

In the example, the four frame corner splicing pieces 53 and partial bottom wall splicing pieces 52 are shared splicing pieces, and can form box bodies of at least two different sizes of the packaging box for liquid crystal glass. Thus, development cost of the mold can be reduced, and the development cycle can be shortened.

The scheme that the bottom wall splicing piece used for forming the bottom wall of the box body is designed into a shared splicing piece can be applied to other examples.

FIG. 13 and FIG. 14 show a fifth example of the forming mold for plastic products of the invention. The shared splicing pieces are used for forming the four frame corners and a part of each side wall of the four side walls of the box body, and the selected splicing pieces are used for forming the bottom wall and the rest part of each side wall of the four side walls of the box body. Specifically, the shared splicing pieces comprise four frame corner splicing pieces 53, and four side wall splicing pieces 51. Each group of selected splicing pieces comprises eight side wall splicing pieces 51, and one bottom wall splicing piece 52. As shown in FIG. 13, a group of small-size selected splicing pieces are used for forming a small-size box body. As shown in FIG. 14, a group of large-size selected splicing pieces are used for forming a large-size box body.

In the example, the four frame corner splicing pieces 53 and partial side wall splicing pieces 51 are shared splicing pieces, and can form box bodies of at least two different sizes of the packaging box for liquid crystal glass. Thus, development cost of the mold can be reduced, and the development cycle can be shortened.

The invention is described in detail in accordance with the above contents with the specific preferred examples. However, this invention is not limited to the specific examples. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A forming mold for plastic products, wherein said mold is used for molding box bodies of at least two different sizes of a packaging box for liquid crystal glass; cavity of said mold is of a splicing structure, and comprises a group of shared splicing piece(s), and at least two groups of selected splicing pieces; the cavities formed by said shared splicing piece(s) and different groups of selected splicing pieces are in different sizes, and are respectively used for forming box bodies of different sizes; said mold further comprises a plurality of cores of different sizes; said cores are respectively matched with said cavities of different sizes.

2. The forming mold for plastic products of claim 1, wherein said shared splicing piece is used for forming the bottom wall of said box body, and said selected splicing pieces are used for forming the four side walls of said box body; or said shared splicing piece is used for forming partial bottom wall of said box body, and said selected splicing pieces are used for forming the four side walls and partial bottom wall of said box body.

3. The forming mold for plastic products of claim 2, wherein the number of said shared splicing piece is one; each group of selected splicing pieces comprise four selected splicing pieces; said four selected splicing pieces are distributed around said shared splicing piece.

4. The forming mold for plastic products of claim 1, wherein said shared splicing pieces are used for forming the middle part of each side wall of the four side walls of said box body, and said selected splicing pieces are used for forming the bottom wall and the four frame corners of said box body.

5. The forming mold for plastic products of claim 4, wherein the number of said shared splicing pieces is four; each group of selected splicing pieces comprises four frame corner splicing pieces, and one bottom wall splicing piece; said four shared splicing pieces and said four frame corner splicing pieces make a rectangle, and said bottom wall splicing piece is positioned in the middle of said rectangle.

6. The forming mold for plastic products of claim 1, wherein said shared splicing pieces are used for forming the four frame corners of said box body, and said selected splicing pieces are used for forming the bottom wall and the four side walls of said box body.

7. The forming mold for plastic products of claim 1, wherein said shared splicing pieces are used for forming the four frame corners of said box body and partial bottom wall of said box body, and said selected splicing pieces are used for forming the four side walls and partial bottom wall of said box body.

8. The forming mold for plastic mold of claim 1, wherein said shared splicing pieces are used for forming the four frame corners and a part of each side wall of the four side walls of said box body, and said selected splicing pieces are used for forming the bottom wall and the rest part of each side wall of the four side walls of said box body.

9. The forming mold for plastic products of claim 1, wherein said core(s) is of a joining structure the same as that of said cavity.

10. A using method of the plastic mold of claim 1, comprising: the following steps:
determining the size of the box body of said packaging box for liquid crystal glass to be produced;
selecting one group of selected splicing pieces from multiple groups of selected splicing pieces corresponding to the size of said box body;
splicing said shared splicing pieces with said selected splicing pieces which are selected, to form cavities; and
selecting matching cores to form a complete mold.

11. A packaging box for liquid crystal glass, comprising: box body(es); wherein said box body is internally provided with buffer blocks which are made of material different from that of said box body and have buffer performance superior to that of said box body; said packaging box for liquid crystal glass comprises two or more sets of buffer blocks of different sizes; multiple sets of buffer blocks enable said packaging box to contain various liquid crystal glass of different sizes.

12. The packaging box for liquid crystal glass of claim 11, wherein said packaging box for liquid crystal glass comprises two or more box bodies of different sizes; the containing sizes of packaging boxes for liquid crystal glass formed by the same set of buffer blocks and different box bodies are different.
